(19) United States
(12) Patent Application Publication
(10) Pub. No.: US 2004/0047543 A1
(43) Pub. Date: Mar. 11, 2004

(54) Ocdma network architectures, optical coders and methods for optical coding

(76) Inventors: Olli-Pekka Hiironen, Helsinki (FI); Markku Oksanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/466,156

(22) PCT Filed: Jan. 13, 2001
(86) PCT No.: PCT/EP01/00374

(51) Int. Cl. G02B 6/26; G02B 6/42

(52) U.S. Cl. 385/16

(57) ABSTRACT

The invention relates to a OCDMA network architectures. In order to achieve a less expensive frequency-hopping coding for a high number of users, the network comprices: a plurality of means (81) for passband filtering and multiplexing broadband signals, each of said means (81) being assigned to a group of users (80) and filtering a broadband signal provided by a user (80) of the respective group with a different frequency passband and multiplexing the filtered signals of the users (80) of one group; a periodic optical coder (82) assigned to each group of users (80) for encoding the signals multiplexed by the means (81) for filtering and multiplexing, each coder (82) using a different code for encoding the signals originating from the different groups; and means (83) for combining the signals output by the coders (82) to a single broadband signal. The invention equally relates to a further architecture, suitable coders and corresponding methods.

### FIELD OF THE INVENTION

The invention relates to OCDMA network architectures and to optical coders. The invention equally relates to methods for multiplexing broadband signals originating from a plurality of users and to methods for optical coding of broadband signals.

### BACKGROUND OF THE INVENTION

Optical fibres allow transmission of signals with a huge bandwidth. A regular sequence of short broadband light pulses supplied by a source can be used as binary signal that is to be transmitted. Each light pulse represents one bit of the signal. A light pulse can be on, representing a “1”, or off, representing a “0” of the binary signal. The distance in time from one light pulse to the next is one bit period. In order to be able to share the bandwidth for several connections, the pulses have to be encoded for transmission. To achieve such an encoding without the need for complicated electronic signal processing, optical code-division multiple access (OCDMA) to the optical fibres by optical coders was introduced. The most common OCDMA systems are coherent or incoherent, synchronous or asynchronous, and based on temporal or spectral coding or on frequency-hopping, which constitutes a combination of temporal and spectral coding. The present invention relates to such coding by frequency-hopping.

One advantages of an OCDMA is the gain from statistical multiplexing, the efficiency of statistical multiplexing increasing with the number of users. The number of users, however, can only be increased by employing longer codes, since in frequency-hopping OCDMA systems typically every user must employ an encoder for a unique coding. In frequency-hopping, the codes can be extended by.increasing the chip rate used for temporal coding or the number of the frequency bands used for frequency encoding. The number of the frequency bands can be increased by broadening the total frequency range or by compressing the single bands. The first alternative is limited by fibre dispersion and the second by component technology. A further problem lies in logistics as the number of users can be very high and each one requires a different coder. Therefore, a large amount of unique coders may have to be provided for each OCDMA network architecture that is to be employed for coding signals from a plurality of users and for multiplexing the coded signals to a single transmission fibre, making the construction rather expensive.

It is known in the state of the art to use Fibre Bragg Grating (FBG) technology or Arrayed Waveguide Grating (AWG) technology for optical coders that are to be employed for coding by frequency-hopping. The use of fibre gratings for frequency hopping coding is e.g. described in “Passive Optical Fast Frequency-Hop CDMA communications System”, H. Fathallah, L. A. Rusch, and S. LaRochelle, J.Lightwave Tecdh., 17. Pp.397-405 (1999).

Fibre gratings can be made very narrow, leading to narrow frequency bands, but they do not solve the logistics problem. In fibre gratings, there can also be problems with reflections. Moreover, systems with fibre gratings require an optical circulator for distributing a broadband signals to different fibre gratings, which can be relatively expensive. With AWG, on the other hand, the logistic problem can be eased slightly, but problems might arise with very dense frequency bands and the insertion loss is quite high with this technology.

### SUMMARY OF THE INVENTION

It is an object of the invention to provide network architectures, optical coders and methods for optical coding that allow for a less expensive optical coding for a high number of users.

This object is reached according to the invention with an OCDMA network architecture, comprising a plurality of means for passband filtering and multiplexing broadband signals, each of said means being assigned to a group of users, and each of said means filtering a broadband signal provided by a user of the respective group with a different frequency passband and multiplexing the filtered signals of the users of one group into a single signal; a periodic optical coder assigned to each group of users for encoding the signals multiplexed by the means for filtering and multiplexing, each coder using a different code for encoding the signals originating from the different groups; and means for combining the signals output by the coders to a single broadband signal.

Periodicity of the to be employed coders means that the coder can code more than one wavelength division multiplexing (WDM) channel simultaneously. This is typically case in non-coherent temporal coding, but not always in coherent temporal coding or in frequency-hopping.

The proposed OCDMA network architecture can be employed for multiplexing the broadband signals from a plurality of users to a single fibre with a reduced total number of coders that have to be used for such a multiplexing. The users of one group are coded simultaneously with the same coder and therefore with the same code, but since they are assigned their own frequency band, the signals of the different users do not mix.

If the users provide a broadband signal that is so broad that it covers the total optical spectrum used in the network, i.e. by the multiplexing means and the coders, every user can use similar sources. The multiplexing means cut for each user only a narrow slice from the broadband spectrum, while the rest is not used for this user. This narrow slice is the actually required width of the spectrum for the user; it is also a broadband signal, even though not as broad as the original supplied broadband signal.

The object of the invention is equally reached with an OCDMA network architecture, comprising a periodic optical coder for each of a plurality of users for encoding a broadband signal originating from the respective user, wherein each user is assigned to one of a plurality of groups, and wherein the optical coders use a different code for the different users of the same group; means for combining the encoded signals of the users of each group into a single broadband signal; and means for filtering the combined signal of each group with a different frequency passband and for multiplexing the filtered signals of the different groups.

The second proposed network architecture equally relies on period coding of the signals provided by the different users. The coders in one group in this network architecture have to use a different code for each user, but the same coders can be used for each group. Therefore, the number of different coders can be reduces drastically, which simplifies logistics and installations.

Compared to the second proposed network architecture, in the first proposed network architecture, the number of coders can be reduced by 1/M, where M is the number users in one group. On the other hand, the second proposed network architecture requires N times less means for filtering and multiplexing, where N is the number of groups. Typically, the number of groups is smaller than the number of users in one group and WDM components that can be used as means for filtering and multiplexing are cheaper than coders, therefore the first proposed network architecture will usually be more cost effective. Still, this may vary with the distribution of users to the groups. In any case, both network architectures enables a reduction of costs compared to the state of the art, where each user uses a separate coder with a different code.

Also corresponding OCDMA network architectures for demultiplexing a broadband signal for different users reach the object of the invention, if they comprise the same means as the respective architecture for multiplexing, but wherein all means are employed in a reversed manner. Equally, corresponding methods for multiplexing broadband signals originating from a plurality of users reach the object of the invention.

There might be different lengths of fibres (0 to N km) between the different components—users, coders, multiplexers/demultiplexers and couplers/splitters—of the proposed network architectures. This is of particular importance between the employed multiplexers and couplers, so different multiplexing stages can be located in different places.

A variety of coders can be used for the proposed network architectures. At least some of them can be temporal coders, which may both comprise serial and/or parallel delay lines, or coherent temporal-and-phase fibre:Bragg grating coders. Alternatively or additionally, at least some of the coders may be spectral phase coders and/or frequency-hopping coders, wherein the frequency hopping coders may comprise AWG, interleavers and/or FBG. All coders must be periodic, i.e. able to code in different WDM channels.

In a preferred embodiment of the network architectures, at least some of the employed components, i.e. of the coders couplers/splitters and multiplexers, can be used bidirectionally in order to enable a bi-directional use of the OCDMA network architecture.

The proposed network architectures can be used as an upgrade to an existing WDM network. This means e.g. that an existing WDM component is one of the WDM components of the new network, or many existing WDM components can be combined to a single fibre. When a network is to be upgraded in order to support more users, additional coders and couplers are inserted to network. The employed coders have to be periodic, or at least to able to code within each passband of WDM multiplexer. Major advantage of such an OCDMA upgrade compared to a normal WDM upgrade is that the WDM components are similar. In normal WDM upgrades, in contrast, the channel spacing may be the same, but the centre frequencies are shifted.

Any of the proposed network architectures can be included in a mixed network architectures, where the outputs of the different network architectures are multiplexed to one single fibre.

The object of the invention is further reached with an optical coder for coding broadband signals, comprising at least one optical interleaver for receiving a broadband signals and for splitting the frequency spectrum of the signal into at least two frequency sets with an interleaved frequency distribution; means for separate coding of at least two of the frequency sets; and means for combining the split and coded frequency sets provided by the means for coding.

The object is equally reached with a corresponding method for coding a broadband signal, comprising:

receiving a broadband signal;

splitting the broadband signal spectrally with at least one optical interleaver into different frequency sets with interleaving frequencies;

coding separately at least two of the frequency sets; and

combining the coded frequency sets to a single broadband signal.

With respect to this coder and this method, the invention proceeds from the idea that optical interleavers can be used for splitting broadband signals into different frequency sets before coding the frequency sets separately. An interleaver is able to separate a broadband signal into at least two separate, interleaved frequency sets with at least twice the channel target spacing. Equally, an interleaver is able to combine at least two separate frequency sets. Interleaver technologies are known for achieving narrow channel spacings of 50 GHz and narrower.

The interleaver technology allows for very dense frequency bands, enabling an efficient use of the available total frequency range. At present, bands of down to 2,5 GHz have been achieved. At the same time, the optical properties of interleavers are comparable to those of FBG and AWG. In addition, the involved all-fibre technology allows for potentially low prices. If interleavers are manufactured with planar technology, several components could even be integrated to. form one coder on a single chip. In the whole, a reduced cost in coding can be expected when employing the above proposed coder and method. In addition, the coder of the invention can be used in different WDM bands, so that the necessary number of different coders can be decreased significantly, leading to cheaper production and easier logistics and installations. In addition, the flexibility for code design is increased with the employment of interleavers for splitting broadband signals that are to be coded.

Interleavers are typically based on different kind of interferometers, like Mach-Zehnder, Michelson, etc., but also fiber bragg grating structures can be used.

The term coding or coder is to be understood to include equally encoding or encoder and decoding or decoder, since the difference consists only in the code that is applied to the respective signal. E.g., if delay lines are used for coding, in a decoder with delay lines that are a time-reversed version of the delay lines used in an encoder, the original broadband signal send to the encoder is recovered. Only if the codes mismatch, the chips are spread along the bit period. The coders can in particular also be employed simultaneously in one direction as encoder and in the opposite direction as decoder.

Preferably, the optical interleaver used in the optical coder of the invention comprises cascaded optical interleavers. The first stage of such a cascade should comprise a single interleaver for receiving a broadband signal and for splitting it into two frequency sets. Each following stage should then comprise the double number of interleavers of the preceding stage so that each frequency set output by one stage is split into two in the next stage, thereby doubling the channel spacing. A cascade of interleavers comprises at least two stages. The stages of the cascade of interleavers can also be combined in a way that a broadband signal input to the cascade is directly interleaved to at least four frequency sets.

The means for separate coding of at least two of the frequency sets can use any coding method. Particularly suited are means for temporal coding, e.g. delay lines. The means for separate coding of at least two of the frequency sets can moreover be suited for coding the frequency sets coherently or incoherently.

Instead of coding all frequency sets, one or several frequency sets can be removed, a coding only being applied to the remaining frequency sets. This can be achieved by preventing one or several of the frequency sets from reaching the means for combining the coded frequency sets, e.g. simply by providing an interruption in the connection to those means.

Just like the at least one interleaver for splitting the incoming broadband signal, the means for combining the split and coded frequency sets can be at least one interleaver, and in particular a cascade of interleavers. In this case, the coder can even be used bi-directionally, each at least one interleaver combining the frequency sets that were provided by the other at least one interleaver after coding. Alternatively, those means for combining can comprise at least one coupler.

The connection between the at least one interleaver and the means for coding are realised advantageously by a separate fibre, waveguide or free space optics for each output frequency set.

The number of necessary interleavers can be reduced by reflecting the frequencies back after coding to the at least one interleaver, which is used in this case in addition for combining the frequency sets again to a single broadband signal. A direction selective component like a circulator should then be provided for separating broadband signals entering and leaving the at least one interleaver. Instead of a circulator, also a directional coupler can be used. If such an embodiment of a coder is to be used bi-directionally and if a circulator is used as direction selective component, the signals from the different directions have to be provided in parallel to the circulator by suitable means, since a circulator is not a bi-directional device.

As explained above, the above proposed coders of the invention can also be used bi-directionally. A bi-directional use of coders halves the number of coders compared to a unidirectional use. Moreover, fewer fibres are required, as long as the available fibre capacity is sufficient for both directions. Another benefit is that with the number of coders and of fibres, also the number of fibre connections is reduced, which makes the system easier to install, since only one fibre is going to each location and it is not possible to misconnect the directions.

However, in the coders proposed above, the chip rate and the pulse length of the broadband signals must be the same in both directions. This requires unnecessary fast transmitters and receivers for one of the directions if an asymmetric connection would be enough.

Therefore, in a preferred embodiment of the coders of the invention, the at least one optical interleaver is suited to be used at the same time as means for combining split and coded frequency sets. Moreover, the means for combining the split and coded frequency sets are formed by a corresponding at least one optical interleaver. The frequency sets provided by any of the two at least one interleavers are then combined after coding by the respective other one of the two at least one interleavers. These features correspond to one of the above mentioned coders that can be used bi-directionally. In addition, however, means are provided for coding each frequency set output by one of at least one interleaver with a separate path of coding. Finally, means for forwarding each output frequency set to a predetermined one of the separate paths of coding depending on their origin are provided.

Alternatively to the at least one interleavers, any other kind of frequency selection and of frequency selective components, like AWGs, WDM filters or FBGs, could be used, as far as they are able to separate both directions simultaneously and as long as they are bi-directional.

A corresponding method comprises:

receiving a broadband signal with a characteristic indicative of the origin of the broadband signal;

splitting the broadband signal spectrally with at least one interleaver into different frequency sets;

determining the origin of the frequency sets;

coding each frequency set separately with a code assigned to the determined origin; and

combining the coded frequency sets to a single signal.

In contrast to the first described coders, this bi-directional coder is able to determine for each formed frequency set from where it originates. For each direction, separate means for coding are provided to which the frequency sets are distributed according to their origin, while sharing means for separating a broadband signal and for combining frequency sets in the respective opposed function. Therefore, this coder allows that different directions may have different bit and chip rates and pulse lengths. Accordingly, this coders enables an efficient employment as bi-directional coders in asymmetric systems. The same applies for the proposed method.

The means for distinguishing between the different origins of a frequency set can be frequency selective components, like WDM components, or direction selective components, like circulators; directional coupler cannot be employed.

Directive selective components enable the use of the same frequencies in both directions. With WDM components, in contrast, different directions have to use-different frequencies. As WDM component, e.g. a band WDM, a course WDM, a dense WDM, an AWG, a FBG or some similar component can be used. Probably most convenient is to use red-band WDM components for one direction and blue-band WDM components for the other direction, or C-band WDM components for one direction and L-band WDM components for the other direction. This kind of coder could probably even be fabricated on single chip.

For a further reduction of frequency splitting components in a coder, also the bi-directional coder of the invention can employ reflection. In this case, the function of the two at least one interleavers are combined in one at least one interleaver, just like the means for distinguishing the origin of frequency sets. Signals from both origins enter the single at least one interleaver. Since both types of signals use the same direction inside of the coder, the means for distinguishing the origin have to be frequency selective. After coding, the signals are simply reflected back to the means for separating and combining signals via the means for distinguishing their origin, which first means are used then for combining the frequency sets. At the output, a direction selective component should be employed for separating incoming and output broadband signals. Such a structure minimises the number of means for splitting the broadband signals, because one interleaver is used four times: to separate and to combine frequency bin chips from both directions.

When a circulator is used as direction selective component. in a bi-directional coder employing reflection, again the signals from the different directions have to be provided in parallel to the circulator by suitable means.

In case delay lines are used for asymmetric bi-directional coding, the length of the delay lines inside the coder can be shorten by using some of the delay lines in common in both directions, wherein the common delay should be equal to the shorter one of the two delays. This would mean that between the employed circulators or WDM components, one branch would be as short as possible and the length of the other branch would be responsible for the difference between the two total delays. Such a combined use of delay lines may be realised by employing a first fibre Bragg grating between a first delay line and a second delay line and a second fibre Bragg grating at the end of the second delay line. A frequency set from either direction enters the delay lines via the first delay line. The first fibre Bragg grating is designed to reflect the frequency band of the frequency set that is to be coded with a shorter delay only by the first delay line and to pass through all other frequency bands. The second fibre Bragg grating is designed to reflect the frequency band of the frequency set that is to be coded with a longer delay by the first and the second delay lines. Therefore, a signal of the first frequency band passes the first delay line twice, and a signal of the second frequency band passes both delay lines twice.

The object of the invention is also reached with an optical coder, comprising a plurality of cascaded coherent coders, wherein each of the cascaded coders is wavelength selective and reflects signals of a corresponding wavelength divisional multiplexing channel back with different amplitudes and phases and passes other wavelength divisional multiplexing channels through.

The coherent coders can be coherent coders as proposed in the applications titled “Method for optical coding, optical coder, and OCDMA network architecture” of the same filing date by the same applicant.

Similarly, the object of the invention is also reached with an optical coder, comprising a plurality of cascaded periodic fibre Bragg gratings (FBG interleavers) composing a periodic frequency hopping coder, wherein each of the cascaded FBG interleavers is designed to reflect a specific frequency set of a provided broadband signal and for passing other frequency sets of the provided broadband signal through, and wherein at least between some. of the FBG interleavers delay lines are provided. The functionally of such a coder is the same as the functionality of an interleaver coder, i.e. it can be used for a periodic frequency-hopping coding. Filters that produces similar frequency sets can be made with FBGs described e.g. in M.Ibsen et. al: “Sinc-Sampled FBG for Identical Multiple Wavelength Operation”, IEEE Photonics Tech. Lett. No.6 June 1998. In periodic frequency hopping coders there would be one such “FBG interleaver” for each frequency set. The fibre Bragg grating FBG reflects a predetermined frequency set and passes other frequencies through. The delays achieved between the FBGs determine the code. Coding over multiple bit periods is especially advantageous here.

The object of the invention is equally reached with a corresponding method. for coding a broadband signal, comprising:

a) receiving a broadband signal;

b) reflecting a first frequency set of the broadband signal with a first FBG grating and passing on all remaining frequency sets of the broadband signal;

c) delaying all passed on frequency sets;

d) reflecting a further frequency set of the broadband signal with a further FBG grating and passing on all remaining frequency sets of the broadband signal;

e) repeating steps c) and d) for all further frequency sets of the broadband signal desired in the coded broadband signal; and

f) combining the reflected frequency sets to a single broadband signal.

The delaying in step c) may be of a length of zero for some repetitions.

Preferred embodiments of the methods of the invention correspond to the above described preferred embodiments of the coders and the network architectures.

The coders of the invention can be employed in particular in the OCDMA network architectures according to the invention. Both, the network architectures and the coders and methods of the invention are based on the periodicity of coding.

Preferred embodiments of the coders, the network architecture and the methods of the invention are moreover included in the subclaims.

The coders and the methods of the invention can be used in particular in frequency-hopping OCDMA systems, especially in IP over fibre networks.

The network architectures, coders and methods according to the invention can be suitably combined with the network architectures, coders and methods proposed in applications of the same filing date by the same applicant, titled “Method and optical coder for coding a signal in an optical fibre network” and the above already mentioned “Method for optical coding, optical coder, and OCDMA network architecture”, both incorporated by reference herewith.

### BRIEF DESCRIPTION OF THE FIGURES

In the following, the invention is explained in more detail with reference to drawings, of which

FIGS. 1a, b illustrate the functioning of an embodiment of an interleaver;

FIG. 2 illustrates the use of interleavers in an embodiment of an optical coder according to the invention;

FIG. 3 shows a first embodiment of a coder according to the invention;

FIG. 4 shows a second embodiment of a coder according to the invention;

FIG. 5 shows a third embodiment of a. coder according to the invention;

FIG. 6 shows a fourth embodiment of a coder according to the invention;

FIG. 7 shows a fifth embodiment of a coder according to the invention;

FIG. 8 shows a sixth embodiment of a coder according to the invention;

FIG. 9 shows a first embodiment of a network architecture according to the invention;

FIG. 10 illustrates the filtering of frequencies in the network architecture of FIG. 9;

FIG. 11 shows a second embodiment of a network architecture according to the invention;

FIG. 12 illustrates the filtering of frequencies in the network architecture of FIG. 11; and

FIG. 13 shows a mixed network architecture according to the invention.

### DETAILED DESCRIPTION OF THE INVENTION

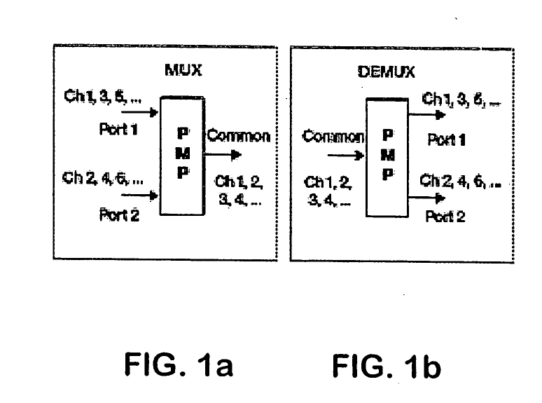

FIG. 1a illustrates the functioning of an interleaver used for combining two separate frequency sets and FIG. 1b illustrates the functioning of an interleaver used for separating a broadband signal into two separate frequency sets.

In FIG. 1a, a first frequency set with channels Ch1,3,5, etc. and a channel spacing of 100 GHZ and a second frequency set with channels Ch2,4,6, etc. and a channel spacing of 100 GHz are fed to port 1 and port 2 respectively of an optical interleaver PMP. As indicated by the numbering of the channels, the frequencies for the different channels are distributed alternatingly to the two frequency sets. The interleaver PMP combines the two frequency sets to a single frequency set with channels Ch1,2,3, etc., the combined frequency set having a target channel spacing of 50 GHz. The combined frequency set is output at the output common of the interleaver PMP. The interleaver in this figure work therefore as multiplexer MUX.

In contrast to the interleaver PMP of FIG. 1a, the interleaver PMP in FIG. 1b is used for splitting signals, i.e. as a demultiplexer DEMUX. A signal with channels Ch1,2,3 etc. and a channel spacing of 50 GHz is fed to the input common of the interleaver PMP. For splitting the received signal, the interleaver PMP distributes the channels Ch1,2,3 etc. alternatingly to two outputs port 1 and port 2, leading to a first frequency set with channels Ch1,3,5, etc. and a second frequency set with channels Ch2,4,6, etc., each frequency set having twice the channel target spacing of 50 GHz. The interleavers of FIGS. 1a and 1b may be the same, only employed in opposite direction.

For transmission of a signal in an optical network, a user outputs short broadband pulses representing a sequence of bits of said signal. In frequency-hopping coding, the temporal frequency pattern constitutes together with the possible empty time slots a 2-dimensional code. It represent optical power values in the time-frequency space. The spectral separation of a broadband pulse for temporal coding can be achieved by the described interleavers.

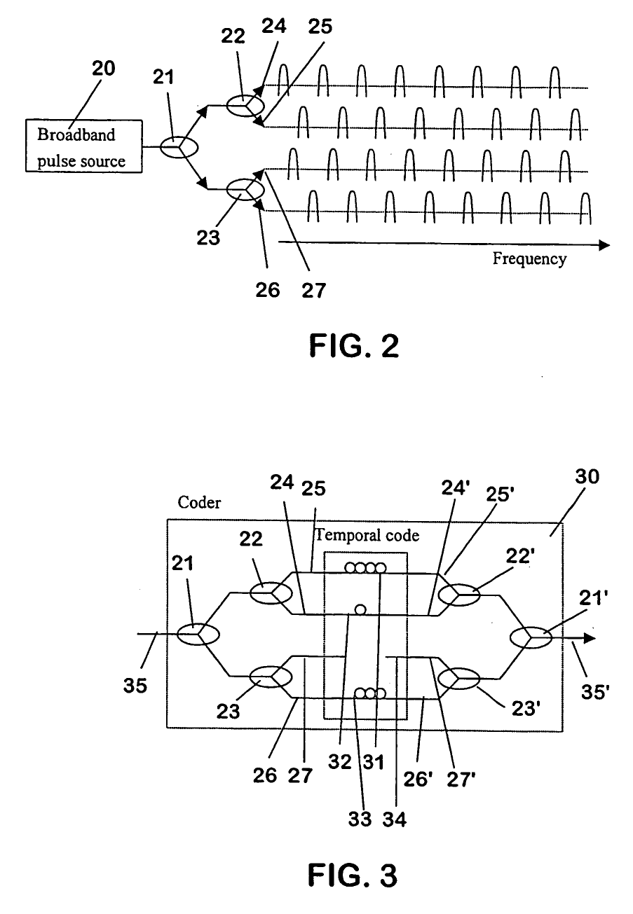

FIG. 2 demonstrates the employment of such interleavers for a frequency-hopping coder according to the invention.

A broadband pulse source 20 is connected to the input of a first interleaver 21. One of the two outputs of the first interleaver 21 is connected to a second interleaver 22 and the other one of the two outputs is connected to a third interleaver 23, the three interleavers 21-23 thus forming a two-stage cascade. The two outputs of the second and the two outputs of the third interleaver 22, 23 are connected each to a separate fibre 24-27.

For indicating the data bit “1”, the broadband pulse source 20 sends a broadband light pulse to the first interleaver 21. The first interleaver 21 divides the spectrum of the received broadband pulse into two frequency sets, as explained with reference to FIG. 1. The second and the third interleaver 22, 24 each receive one of the frequency sets output by the first interleaver 21 and divide the respective received frequency set in the same manner again into two frequency sets, thus forming in the whole four different frequency sets. Each frequency set is fed to the fibre 24-27 connected to the respective output of the second and the third interleaver 22, 23. The frequencies are distributed alternatingly to the four frequency sets so that any chosen frequency band comprising four consecutive frequencies comprises one frequency in each of the four sets. The frequency sets constitute chipsets with a chip present for every frequency of the respective frequency set for each broadband pulse that is input to the cascade of interleavers 21-23. The four frequency sets are indicate in FIG. 2 as four sequences of chips with a frequency increasing from the left to the right side, each frequency set being assigned to one of the outputs of the cascade.

In more general terms, the cascaded interleavers 21-23 divide the spectrum into N_{f} frequency sets. Since each interleaver divides a received signal into two frequency sets, N_{f} is fixed by the employed number (n) of interleaver stages to N_{f}=2ⁿ. Therefore, the number of stages of the cascade are determined depending on the spectral code length that is to be achieved. In the cascade, the first interleaver has an input channel spacing of SP, and in the following stages, the interleavers of the nth stage have a spacing of 2ⁿ⁻¹*SP. The frequencies in the fibres are thus separated by N_{f}*SP. The number of the frequencies in each frequency-set depends on the bandwidth of the broadband pulse source 20. Sometimes, however, the employed interleavers may constitute a limiting factor.

FIG. 3 shows a first embodiment of a complete coder 30 including the interleavers 21-23 of FIG. 2 for spatial splitting of an incoming broadband signal.

The coder 30 comprises the cascaded interleavers 21-23 of FIG. 2, to the input of which an optical fibre 35 is connected. Each output of the second and the third interleaver 22, 23 is connected via a separate fibre 24-27 to a delay line 31-34 causing a different temporal delay. The delay line 33 connected to the first output of the third interleaver 23 comprises an interruption. The delay lines 34-37 are connected again via separate fibres 24′-27′ to a second cascade of interleavers 21′-23′ which is formed mirror-wise to the first cascade of interleavers 21-23. That means, the two fibres 24, 25 connected to the outputs of the second interleaver 22 are connected via delay lines 31,32 and fibres 24′, 25″ to two inputs of a forth interleaver 22′ and the two fibres 26, 27 connected to the outputs of the third interleaver 23 are connected via delay lines 33, 34 and fibres 26′, 27′ to two inputs of a fifth interleaver 23′. The outputs of the fourth and the fifth interleavers 22′, 23′ are connected to two inputs of a sixth interleaver 21′. The sixth interleaver 21′ has a single output connected to a single fibre 35′.

If a short broadband pulse originating from a broadband pulse source 20 (not shown in FIG. 3) is inserted to the coder 30 via fibre 35, the pulse is first divided into N_{f}frequency sets by the first cascade of interleavers 21-23 as explained with reference to FIG. 2.

After the spectral split, the frequencies of the frequency sets are to be temporally coded either coherently or incoherently. To this end, each of the frequency sets is delayed individually by the delay line 31-34 connected to the output of the second and the third interleaver 22, 23 outputting the respective frequency set. The different lengths of the delay lines 31-34 leading to a different temporal coding of the frequency sets are indicated by different numbers of loops in three of the delay lines 31, 32, 34. Since the delay line 33 between the first output of the third interleaver 23 and the first input of the fifth interleaver 23′ is interrupted, the first frequency set output by the third interleaver 23 is not coded but removed.

The coded frequency sets are forwarded to the interleavers 21′-23′ of the second cascade via the respective fibres 24′-27′. The second cascade functions in an exactly reversed way as the first cascade. Accordingly, the second cascade of interleavers 21′-23′ combines the coded frequency sets again and feeds the combined signal to the single fibre 35′, the combined signal having a minimal channel spacing of SP. In the resulting signal, each of the chipsets propagates in the single fibre 35′ in different time slots, while each chipset consists of many frequencies. Therefore, the input short broadband pulse was coded in frequency and in time. Because an optical interleaver is a periodic device, the broadband pulse can be located at any place in the frequency band, if the width of the input pulse is greater than or equal to N_{f}*SP.

The bits are decoded and detected incoherently.

The described coder of FIG. 3 can be used bi-directionally.

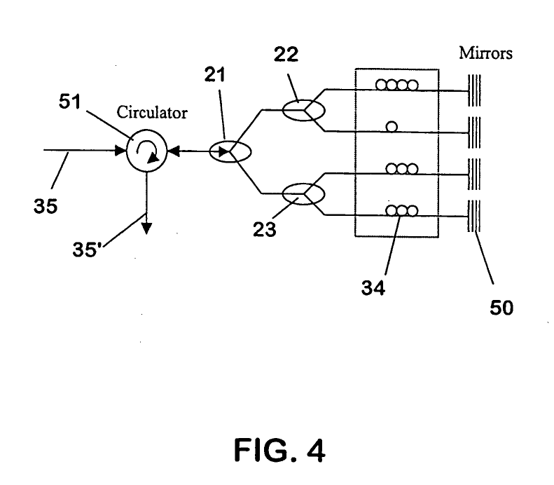

FIG. 4 shows a second embodiment of a complete coder similar to the one in FIG. 3, but which requires less interleavers by making use of reflectors.

The first cascade of interleavers 21-23 and the delay lines 34 are arranged identically as in FIG. 3. Each delay line 34 is terminated, however, by a respective mirror or reflector 50. A second cascade of interleavers is not provided. Instead, the first interleaver 21 of the cascade of interleavers 21-23 is connected via a circulator 51 to both, an input and an output fibre 35, 35′.

When a short broadband pulse originating from a broadband pulse source 20 (not shown) arrives on fibre 35, it is forwarded by the circulator 51 to the first stage of the cascade of interleavers 21-23. As described with reference to FIG. 3, the broadband signal is first divided into N_{f} frequency sets, and then each frequency set is temporally delayed by the respective delay line 34. When reaching the end of the delay lines 34, however, the frequency sets are now reflected by the respective reflector 50. The reflected frequency sets therefore pass the respective delay line 34 a second time in reversed direction, until they reach the single cascade of interleavers 21-23 again. This cascade is then used in addition for combining the delayed frequency sets to a single signal, which is forwarded by the circulator 51 to the output fibre 35′.

The coder of FIG. 4 cannot be used bi-directionally without further supplements, but it requires only one cascade of interleavers 21-23 by using it for dividing and for combining of signals.

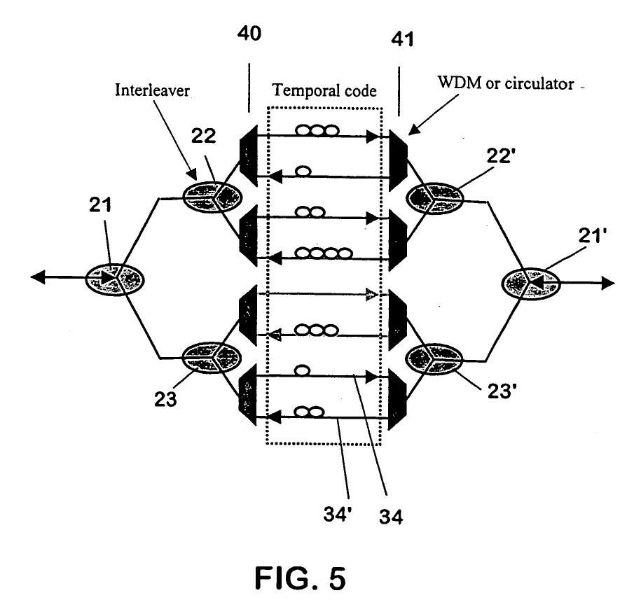

A third embodiment of a frequency-hopping coder according to the invention is shown in FIG. 5. The structure of the coder is similar to the one depicted in FIG. 3, but in order to allow for an independent bi-directional coding, some additional components have been included.

A first cascade of interleavers 21-23 like the one described with reference to FIG. 2 is connected on the one hand via its first-stage interleaver 21 to a generator/receiver of broadband light pulses (not shown). On the other hand, both connections of each of the two interleavers 22, 23 of the second stage facing away from the cascade are coupled to a respective WDM component 40. A second shown cascade of interleavers 21′-23′ has an identical structure, inclusive WDM components 41. Each WDM component 40 of the first cascade is provided with two connections facing away from the first cascade, each connection being connected to corresponding connections of the WDM components 41 of the second cascade via fibres and delay lines 34, 34′, of which only the delay lines connected to the second output of the third interleaver 23 are provided with reference signs. All used WDM components 40, 41 are identical. Instead of the WDM components 40, 41, circulators can be employed.

Short broadband pulses entering the first cascade via the first interleaver 21 are separated by the corresponding interleavers 21-23 into four different frequency sets as described with reference to FIG. 2. The same interleavers 21-23 combine frequency sets coming from the opposite direction and output them as single signal. Equally, short broadband pulses entering the second cascade via the sixth interleaver 21′ are separated by the corresponding interleavers 21′-23′ into four different frequency sets, while the same interleavers 21′-23′ combine frequency sets coming from the opposite direction.

The WDM components 40,41 are used for distinguishing between different directions. Frequency sets output by the first cascade are directed by the respective WDM components 40 to the respective first ones of the delay lines 34. Those frequency sets are received by the respective WDM components 41 of the second cascade and forwarded to interleavers 21′-23′. Frequency sets output by the second cascade are directed by the respective WDM components 41 to the respective second ones of the delay lines 34′. Those frequency sets are received by the WDM components 40 of the first cascade and forwarded to interleavers 21-23. Accordingly, frequency sets coming from different directions can be delayed by different delay lines 34, 34′, and therefore be temporally coded independently.

If circulators are used instead of WDM components 40, 41, the same frequencies can be used in both directions, since a circulator is a direction selective component. If WDM components are used, different directions have to use different frequencies, since these components are only frequency selective.

Because interleavers are periodic the described coders are also periodic, but with the coder of FIG. 5, now different codes can be used in different directions.

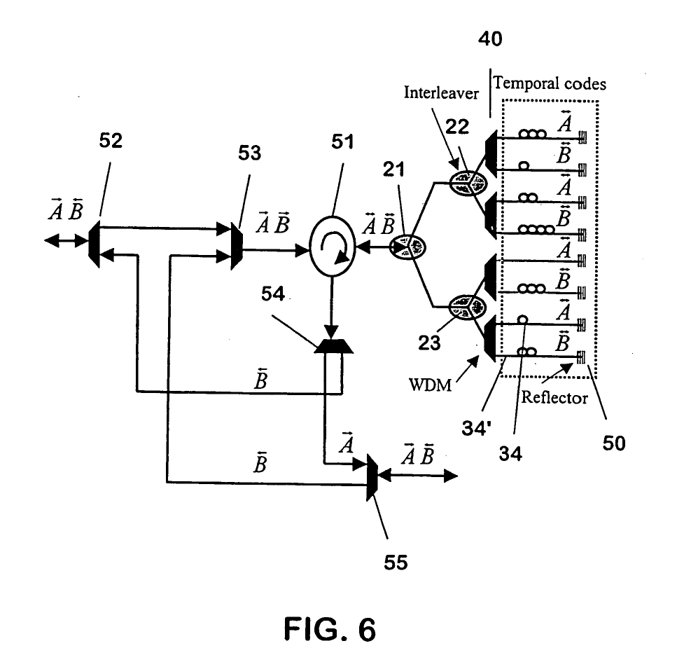

FIG. 6 shows a fourth embodiment of a frequency-hopping coder according to the invention. It constitutes an alternative bi-directional coder that is also able to code broadband pulses from both directions independently, like the coder of FIG. 5. But additionally, it comprises reflectors similar to the coder of FIG. 4.

A single cascade of interleavers 21-23 composed of a first interleaver 21 in the first stage and two interleavers 22, 23 in the second stage is connected via WDM components 40 for each output of the interleavers 22, 23 of the second stage to two different delay lines 34, 34′ respectively. Again only the delay lines connected to the outputs of the third interleaver 23 are provided with reference signs. Each delay line 34, 34′ is terminated by a reflector 50. The interleaver 21 of the first stage of the cascade is connected on the side facing away from the cascade to a circulator 51, which is in turn connected to means for supplying pulses from different directions in parallel. Those means comprise four WDM components 52-55. WDM component 52 is connected on the one hand to a first broad band pulse source (not shown) and on the other hand via WDM component 53 and via WDM component 54 to the circulator 51. WDM component 55 is connected on the one hand to a second broad band pulse source (not shown) and on the other hand via WDM component 53 and via WDM component 54 to the circulator 51.

The two broadband pulse sources provide signals from two different directions. The use of the WDM components 40, 52-54 requires that the different directions have different frequencies.

All signals originating from the first broadband pulse source are referred to in the figure by A and all signals originating from a second broadband pulse source are referred to by B. Incoming broadband light pulses are first arranged in parallel by the WDM components 52-55, because the circulator 51 is not a bi-directional device. Broadband light pulses A have to pass WDM component 52 before reaching the circulator 51 via WDM component 53 and broadband light pulses B have to pass WDM component 55 before reaching the circulator 51 via the same WDM component 53. Signals A, B from both directions are fed via the WDM components 52-54 and the circulator 51 to the first stage of the cascade of interleavers 21-23.

In the cascade of interleavers 21-23, the broadband pulses are split into four different frequency sets as described with reference to FIG. 2. The WDM components 40 are able to distinguish between the frequency sets A, B coming from different directions. Frequency sets A originating from the first direction are forwarded by the WDM components 40 to the respective delay lines 34 connected to the first connections of the respective WDM component 40. Frequency sets B originating from the second direction are forwarded to the delay lines 34′ connected to the second connections of the respective WDM component 40. The frequency sets are therefore delayed independently, leading to a different temporal coding of the frequency sets A, B of the different directions. At the end of each of the delay lines 34, 34′, the reflectors 50 reflect the frequency sets A, B back to the connection of the WDM component 40 from which they were output. The WDM components 40 pass the encoded and reflected frequency sets on to the cascade of interleavers 21-23. The interleavers 21-23 of the cascade combine the frequency sets A or B again and form a broadband signal A, B for output to the circulator 51. The direction selective circulator 51 separates the incoming signals from the signals output by the cascade. The WDM components 52-55 direct the output signals A, B again to opposite directions. Broadband signal B originating from the second source is forwarded to the first source via WDM components 54 and 52 and broadband signal A originating from the first source is forwarded to the second source via WDM components 54 and 55.

The proposed encoder minimises the number of interleavers, because each interleaver 21-23 is used four times.

The means 52-55 for supplying pulses from different directions in parallel to the direction selective component can be used equivalently with the encoder of FIG. 4 for enabling a bi-directional use of the coder with the same codes in both directions.

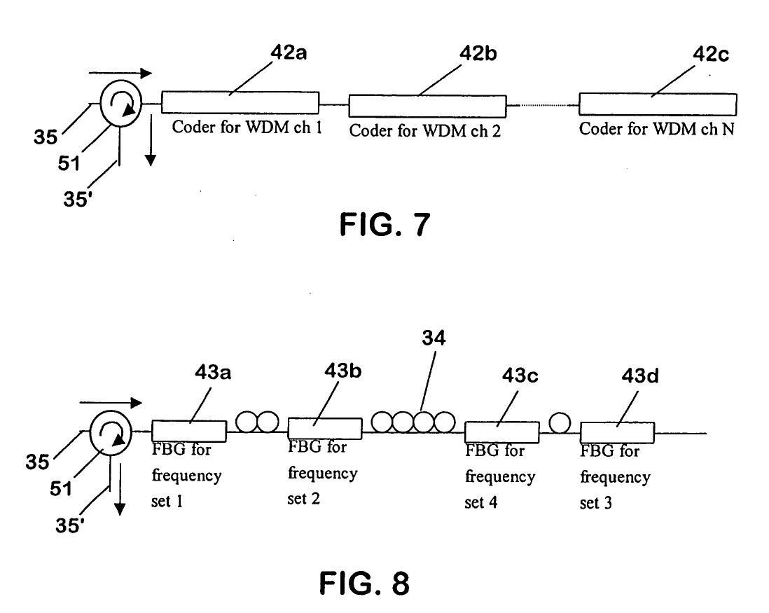

FIG. 7 shows an embodiment of another coder according to the invention. This coder is composed of several separate coherent coders 42a to 42c.

A circulator 51 is connected to two fibres 35, 35′ and to a cascade of N coherent coders 42a to 42c, of which only the first two and the N^{th} are shown. Each of the coherent coders 42a to 42c is formed by fibre Bragg gratings. Each coder 42a to 42c is designed to code another one of N different WDM channels ch1-chN.

When a broadband signal arrives via the first one of the fibres 35, it is forwarded by the circulator 51 to the first coder 42a, where a first WDM channel ch1 included in the signal is reflected with different amplitudes and phases. All other WDM channels ch2-chN are passed through to the second coder 42b. The second coder 42b reflects a second WDM channel ch2 included in the signal with different amplitudes and phases and passes through all remaining WDM channels to the following coders, each reflecting a specific WDM channel and passing the other received channels through to the next coder until the Nth coherent coder 42c is reached. Finally, the Nth coder 42c reflects an N^{th} WDM channel chN included in the signal with different amplitudes and phases. The order of the coders provided for the different channels ch1-chN can be chosen arbitrarily.

The reflected WDM channels are forwarded as coded signal by the circulator 51 to the second fibre 35′.

FIG. 8 shows an embodiment of a coder according to the invention, which constitutes a coder composed of several fiber Bragg grating interleavers, and which can be employed for periodic frequency-hopping coding.

A circulator 51 is connected to two fibres 35, 35′ and to a first FBG interleaver 43a. The first interleaver 43a is connected via a delay line 34, a second interleaver 43b, a second delay line 34, a third interleaver 43c and a third delay line 34 to a fourth interleaver 43d. Each interleaver 43a to 43c is designed to reflect another one of 4 different frequency sets 1-4. The lengths of the employed delay lines 34 is indicated by the different numbers of loops in each line.

Like in the example of FIG. 7, a broadband signal arriving via the first one of the fibres 35 is forwarded by the circulator 51 to the first interleaver 43a, where a first frequency set 1 included in the broadband signal is reflected. All other frequency sets 2-4 are passed through to the first delay line 34, delaying those passed through frequency sets 2-4 with a first delay. The delayed frequency sets 2-4 are then forwarded to the second interleaver 43b, where again a certain frequency set 2 included in the broadband signal is reflected, while all other frequency sets 3,4 are passed through to the second delay line 34. Two further frequency sets 3,4 included in the broadband signal are additionally delayed in the same way by the second delay line 34 and the third interleaver 43c and the third delay line 34 and the fourth interleaver 43d. Frequency set 4 is reflected in the interleaver 43c and frequency set 3 in the interleaver 43d. In case there are more frequency sets included in the broadband signal, additional delay lines and interleavers may be provided.

The reflected signals are delayed again by each delay line 34 they pass on their way back to the circulator 51, which leads to the complete temporal coding of the different frequency sets of the broadband signal. The complete delays of each frequency set, i.e. the order of the interleavers and the lengths of the delay lines between the interleavers, constitute the code applied to the complete signal for coding by frequency-hopping. The reflected coded signals are forwarded by the circulator 51 to the second fibre 35′ as a single frequency-hopping coded signal. The same time slot in a code cannot be used twice.

In the following, a possible employment of a coder according to the invention in a network architecture according to the invention is described.

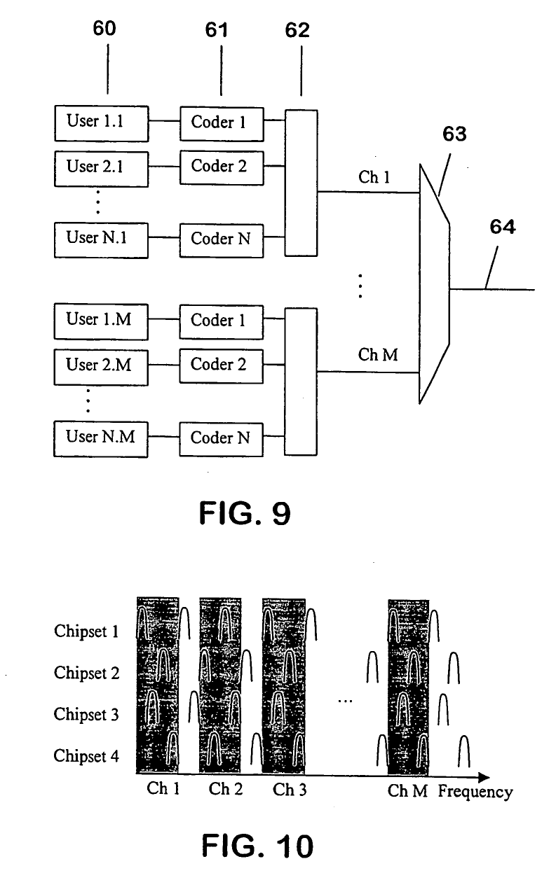

FIG. 9 shows a first possibility of an integration of encoders according to the invention in a network architecture used for encoding the signals originating from a plurality of users 60.

Each of a plurality of users 60 is connected to a separate encoder 61. The users 60 are grouped into M groups, each group comprising N users. The output of the encoders 61 belonging to the users 60 of one group are connected to the inputs of one of M couplers 62. The output of each coupler 62 is connected to one of M inputs of a WDM multiplexer 63. The single output of the WDM multiplexer is. connected to a single optical fibre 64.

Each user 60 outputs short broadband light pulses representing binary data that is to be transmitted via the optical fibre 64. The short broadband pulses are encoded separately for each user 60 in the corresponding encoder 61. Each encoder 61 corresponds to the encoder described with reference to FIG. 3 and outputs a signal with N_{f}chipsets. Within each group of users 60, each encoder 61 apply a different code to the respectively received broadband pulses. The maximum number of users for each group depends on the codes.

In order to extend the total number of users using one fibre 64, the coded signals from N users are combined respectively by one of the couplers 62, each coupler 62 outputting a WDM channel Ch1-ChM. Even though the same frequency sets are used for all users of one group, their signals can be differentiated within one channel Ch1-ChM because of the different temporal coding employed by the encoders 61 of one group.

The channels Ch1-ChM are then forwarded to the WDM multiplexer 63. In the WDM multiplexer 63, to each channel Ch1-ChM there is assigned a dedicated frequency passband. For each channel Ch1-ChM, the multiplexer 63 passes through only those frequencies from the combined frequency sets that belong to the passband of the respective channel Ch1-ChM. The filter is designed in a way that it passes exactly one frequency of each of the N_{f} frequency sets for each channel Ch1-ChM. All other frequencies are removed for that channel.

The filter can be in any part of the frequency set, if it only selects N_{f} adjacent frequencies for each channel Ch1-ChM.

The selection of frequencies from the frequency sets is illustrated in FIG. 10, where the chips of the different chipsets of the first channel Ch1 pass through the WDM multiplexer 63 if they lie in the frequency band of the first grey area. Correspondingly, the chips of the second channel Ch2 pass through the WDM multiplexer 63 if they lie in the frequency band of the second grey area etc.

After multiplexing, only N_{f} adjacent frequencies originate from one encoder 61. If some frequency sets have been removed by the encoder 61, even less frequencies originate from that encoder. If the coders and the WDM multiplexers are not perfectly aligned, there might be not exactly N_{f} frequencies, but e.g. N_{f}−1 full power frequencies and two half power frequencies. But this is compensated at the receiving end, since these two half power frequencies are delayed equally in the coders, so they form one full power frequency at the receiver.

Since for every channel Ch1-ChM and therefore for every group of users 60 only a limited frequency band is admitted to the common fibre 64, the encoders 61 have to be different within the same group, but the same set of encoders 61 can be used in all groups.

For regaining the pulses output by the users, which is not illustrated here, the WDM channels are separated again by demultiplexing, and signals with N_{f} adjacent chips are routed to a decoder for each user, which combine the chips originating from a corresponding encoder to pulses again. If bi-directional coders are employed, the same network architecture can be used for encoding and for decoding.

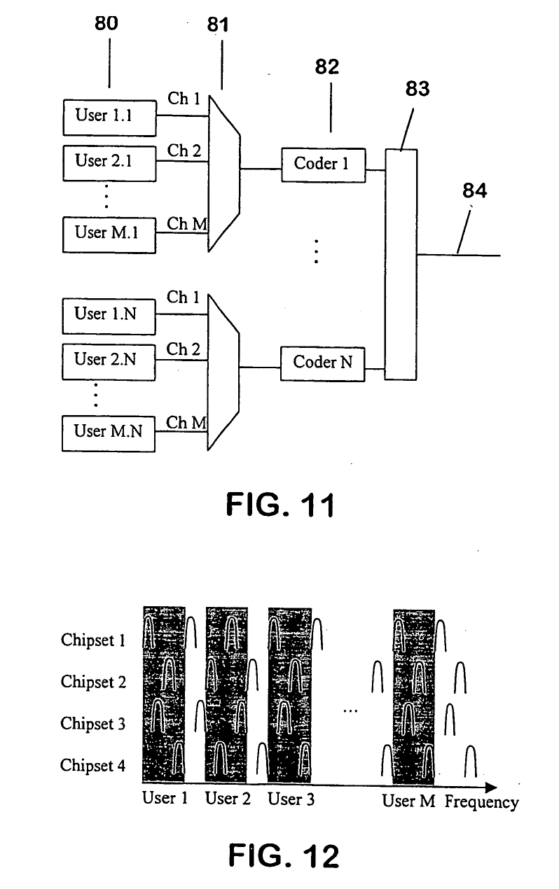

FIG. 11 shows a second possibility of an integration of encoders according to the invention in another network architecture according to the invention used for encoding the signals originating from a plurality of users 80.

Like in the network architecture of FIG. 9, the users 80 are grouped in N groups, each group comprising M users 80. But in contrast to the architecture of FIG. 9, the users 80 of each group are first connected to a separate WDM multiplexer 81. Only the output of each of the N multiplexers 81 is connected to a separate encoder 82. The output of each of the N encoders 82 is connected in turn to one of the N inputs of a coupler 83. The coupler 83 has a single output connected to a single optical fibre 84.

Each user 80 of each group outputs broadband pulses as a channel Ch1-ChM with a width greater than or equal to N_{f}*SP. N_{f} is again the number of frequency sets generated in each encoder 82 for encoding, and SP is the channel spacing of the first interleaver of the first cascade in the encoders, as described with reference to FIG. 2. The channels Ch1-ChM of all M users 80 of one group are fed to the inputs of the WDM multiplexer 81 assigned to the respective group.

Each multiplexer 81 combines the signals from the M users 80 of one group, but passes through for each user 80 only those frequencies that lie within the range of a passband reserved for the respective user 80 or channel Ch1-ChM. Each passband should have a width of about N_{f}*SP. Accordingly, each multiplexer 81 outputs a combined signal with a separate frequency band for each user 80 of one group, as illustrated in FIG. 12. Each grey area highlights in the different chipsets the frequencies of the frequency passband assigned to one user 80 of one group.

Now, the signal with the filtered and multiplexed channels are fed to the coder 82 assigned to the respective group of users 80. The coder 82 encodes the input signal as described with reference to FIG. 3.

Each coder 82 encodes the signals of the M users 80 of one group simultaneously with the same code. But since within their group the M users 80 have their own frequency band, the signals of the different users 80 do not mix. After coding, the signals from the different user groups are combined by the coupler.83. Because the same frequencies may be assigned to users 80 of different user groups, the N coders 82 must apply different OCDMA codes. The maximum number of user groups depends therefore on the number of provided coders 82 with different codes.

Demultiplexing and decoding occurs with a similar network architecture in the opposite direction. If bi-directional coders are employed, the same network architecture can be used for encoding and for decoding.

As became apparent, the second embodiment of a network architecture has the advantage over the first embodiment of a network architecture that each coder can be used for a whole group of users, thereby reducing the required number of coders drastically.

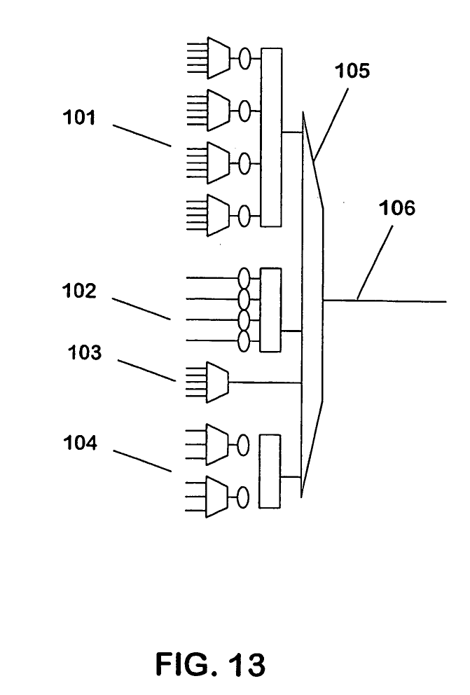

As demonstrated in FIG. 13, different embodiments of network architectures 101-104 can be combined in a mixed network architecture, which permits a very flexible network design. The mixed architecture of FIG. 13 combines one network architecture 102 of the first described embodiment and two different network architectures 101, 104 of the second described embodiment. In addition, a multiplexer 103 outputting multiplexed signals without encoding is comprised. In the mixed architecture, rectangles represent couplers, circles represent coders and trapeziums represent WDM components. The signals output by each network architecture 101-104 are fed to a multiplexer 105, which multiplexes all provided signals in a suitable manner to a single optical fibre 106.

1. OCDMA network architecture, comprising:
a plurality of means (81) for passband filtering and multiplexing broadband signals, each of said means (81) being assigned to a group of users (80), and each of said means (81) filtering a broadband signal provided by a user (80) of the respective group with a different frequency passband and multiplexing the filtered signals of the users (80) of one group into a single signal;
a periodic optical coder (82) assigned to each group of users (80) for encoding the signals multiplexed by the means (81) for filtering and multiplexing, each coder (82) using a different code for encoding the signals originating from the different groups; and
means (83) for combining the signals output by the coders (82) to a single broadband signal.

2. OCDMA network architecture, comprising:
means for separating a broadband signal generated by an OCDMA network architecture according to claim 1 into encoded signals of one group of users;
a periodic optical coder for each group of users for decoding the signals of one group of users; and
means for demultiplexing the decoded signals of one group of users into the signals of one user respectively, a certain frequency band belonging to each user of a group.

3. OCDMA network architecture, comprising:
a periodic optical coder (61) for each of a plurality of users (60) for encoding a broadband signal originating from the respective user (60), wherein each user (60) is assigned to one of a plurality of groups, and wherein the optical coders (61) use a different code for the different users (60) of the same group;
means (62) for combining the encoded signals of the users (60) of each group into a single broadband signal; and
means (63) for filtering the combined signal of each group with a different frequency passband and for multiplexing the filtered signals of the different groups.

4. OCDMA network architecture, comprising:
means for demultiplexing a signal generated by an OCDMA network architecture according to claim 3 into signals of one group of users;
means for separating the signal of each group into coded signals of the different user of each group; and
a periodic optical coder assigned to each user for decoding the coded signals of each user and for outputting a decoded broadband signal for each user.

5. OCDMA network architecture according to one of the preceding claims, wherein the periodic optical coders are temporal coders, coherent temporal-and-phase fibre Bragg grating coders, spectral phase coders, and/or frequency-hopping coders.

6. OCDMA network architecture according to claim 5, wherein the temporal coders comprise serial and/or parallel delay lines.

7. OCDMA network architecture according to claim 5, wherein the periodic coherent temporal-and-phase fibre Bragg grating coders comprise cascaded coherent FBG coders.

8. OCDMA network architecture according to claim 5, wherein the frequency hopping coders comprise arrayed waveguide gratings, interleavers and/or fibre Bragg gratings.

9. OCDMA network architecture according to one of the preceding claims, wherein at least some of the employed components (61,62,63,81,82,83) can be used bi-directionally in order to enable a bi-directional use of the OCDMA network architecture.

10. OCDMA network architecture according to one of the preceding claims, wherein the users (60,80) and the different components (61,62,63,81,82,83) are connected by fibres of arbitrary lengths.

11. OCDMA network architecture according to one of the preceding claims, wherein the users comprise broadband signal sources for providing a broadband signal that is at least as broad as the complete spectrum used in the network architecture, and wherein the different users have a similar source.

12. Mixed OCDMA network architecture, comprising a multiplexer (105) for combining the signals originating from different network architectures (101-104), wherein at least one of the network architectures is a network architectures according to one of the preceding claims.

13. Optical coder (30) for coding-broadband signals, comprising:
at least one optical interleaver (21-23) for receiving broadband signals and for splitting the frequency spectrum of the signals into at least two frequency sets with an interleaved frequency distribution;
means (31-34) for separate coding of at least two of the frequency sets; and
means (21′-23′) for combining the split and coded frequency sets provided by the means (31-34) for coding.

14. Optical coder according to claim 13, wherein the at least one optical interleaver comprises a cascade of optical interleavers (21-23).

15. Optical coder according to claim 14, wherein each interleaver (21-23) of the cascade is suited for splitting a received frequency spectrum into two frequency sets, wherein each stage of the cascade comprises two interleavers (22,23) for each interleaver (21) of the previous stage, wherein the first stage comprises one interleaver (21), wherein the cascade comprises at least two stages, and wherein the broadband signal is fed to the interleaver (21) of the first stage.

16. Optical coder according to claim 15, wherein the stages of the cascade of interleavers are combined in a way that a broadband signal input to the cascade is directly interleaved to at least four frequency sets.

17. Optical coder according to one of claims 13 to 16, wherein the means for separate coding of at least two of the frequency sets are means for temporal coding including a delay line (31-34) for each frequency set.

18. Optical coder according to one of claims 13 to 17, wherein the means (31-34) for separate coding of at least two of the frequency sets are suited for coding the frequency sets coherently or incoherently.

19. Optical coder according to one of claims 13 to 18, wherein the means (34) for separate coding of at least two of the frequency sets are suited for preventing at least one of the frequency sets from being input to the means (21′-23′) for combining the split and coded frequency sets.

20. Optical coder according to one of claims 13 to 19, wherein the means (21′-23′) for combining the split and coded frequency sets include a second at least one interleaver or at least one coupler.

21. Optical coder according to one of claims 13 to 20, wherein the split frequency sets are provided from the at least one interleaver (21-23) to the means (31-34) for coding via separate fibres (24-27), waveguides or free space optics.

22. Optical coder according to one of claims 13 to 21, wherein the interleavers are manufactured with planar technology and are integrated with other components of the optical coder on a single chip.

23. Optical coder according to one of claims 13 to 22, wherein
the at least one optical interleaver (21-23) is suited to be used at the same time as means for combining split and coded frequency sets;
the means for combining the split and coded frequency sets (21′-23′) is at least one optical interleaver and suited at the same time for receiving broadband signals of a second origin and for splitting the frequency spectrum of the signals into at least two frequency sets with an interleaved frequency distribution; and wherein
frequency sets provided by the at least one optical interleaver (21-23) are combined after coding by the means for combining the split and coded frequency sets (21′-23′) and the frequency sets provided by the means for combining the split and coded frequency sets (21′-23′) are combined after coding by the at least one optical interleaver (21-23).

24. Optical coder according to one of claims 13 to 22, further comprising reflection means (50) for reflecting each frequency set output by the means (31-34) for coding back through said means (31-34) for coding to the at least one interleaver (21-23), the at least one interleaver (21-23) forming at the same time the means for combining the frequency sets, and a direction selective component (51) for separating broadband signals (A,B) entering and leaving the at least one interleaver.

25. Optical coder according to claim 24, further comprising means (52-55) for supplying broadband signals to the direction selective component (51) from different directions in parallel.

26. Optical coder according to claim 23, wherein
the means for separate coding of each frequency set comprise two separate paths (34;34′) of coding for each frequency set output by the at least one optical interleaver (21-23) or the means for combining the split and coded frequency sets (21′-23′); and
means (40) are provided for forwarding each provided frequency set to a predetermined one of the separate paths (34,34′) of coding depending on the origin of the frequency set.

27. Optical coder according to claim 26, wherein the means (40) for distinguishing between the frequency sets output and received by the first at least one optical interleaver (21-23) and the means (41) for distinguishing between the frequency sets output and received by the second at least one optical interleaver (21′-23′) are frequency or direction selective components.

28. Optical coder according to claim 26, wherein the means (40) for distinguishing between the frequency sets output and received by the first at least one optical interleaver (21-23) and the means (41) for distinguishing between the frequency sets output and received by the second at least one optical interleaver (21′-23′) are circulators.

29. Optical coder according to claim 26, wherein the means (40) for distinguishing between the frequency sets output and received by the first at least one optical interleaver (21-23) and the means (41) for distinguishing between the frequency sets output and received by the second at least one optical interleaver (21′-23′) are WDM components distinguishing between different frequencies of the frequency sets.

30. Optical coder according to one of claims 13 to 22, wherein
the at least one optical interleaver (21-23) is suited for receiving broadband signals and for splitting the frequency spectrum of the signal into at least two frequency sets with an interleaved frequency distribution and for receiving simultaneously at least two frequency sets and for combining the frequency sets to a single broadband signal, the at least one interleaver (21-23) thus forming at the same time the means for combining the frequency sets;
the means for separate coding of each of the frequency sets comprise different paths (34;34′) of coding for each frequency set, each path being assigned to different frequencies;
frequency selective components (40) are provided for determining the frequencies of each frequency set output by the at least one interleaver (21-23) and for forwarding the frequency sets to the respective paths (34;34′) of the means for coding and for forwarding frequency sets arriving from both paths (34;34′) to the at least one interleaver (21-23);
means (50) are provided for reflecting the coded frequency sets back through the means (34;34′) for separate coding and the frequency selective components (40) to the at least one optical interleaver (21-23); and
wherein a direction selective component (51) is provided for separating broadband signals entering and leaving the at least one optical interleaver (21-23).

31. Optical coder according to claim 30, further comprising means (52-55) for supplying broadband signals to the direction selective component (51) from different directions in parallel.

32. Optical coder according to one of claims 26 to 31, wherein delay lines (34,34′) are used as means for coding and wherein for at least some of the frequency sets a part of a delay line is used in common in both directions.

33. Optical coder according to claims 32, wherein a first part of a delay line, to be used in common by two portions of a frequency set, is connected to a second part of a delay line, to be used only by one of the two portions of the frequency set, via fibre Bragg gratings designed to reflect the portion of the frequency set used for a first direction, and wherein the second part of the delay line is terminated by fibre Bragg gratings designed to reflect a portion of a frequency set used for a second direction.

34. Optical coder, comprising a plurality of cascaded coherent coders (42a-42c), wherein each of the cascaded coders (42a-42c) is wavelength selective and reflects signals of a corresponding wavelength divisional multiplexing channel back with different amplitudes and phases and passes other wavelength divisional multiplexing channels through.

35. Optical coder, comprising a plurality of cascaded periodic fibre Bragg gratings (43a-43d), wherein each of the gratings (43a-43d) is designed to reflect a specific frequency set of a provided broadband signal and for passing other frequency sets of the provided broadband signal through, and wherein at least between some of the gratings (43a-43d) delay lines (34) are provided.

36. Optical coder according to one of claims 13 to 35 used as encoder or as decoder.

37. Optical coder according to one of claims 13 to 36 used simultaneously as encoder in one direction and as decoder in the opposite direction.

38. Optical coder according to one of claims 13 to 37 used in an OCDMA network architecture of one of claims 1 to 11.

39. Method for multiplexing broadband signals originating from a plurality of users (80), comprising
for each group of a plurality of groups of users (80), filtering broadband signals provided by the users (80) of one group with a different frequency passband for each user (80) and multiplexing the filtered signals of the users (80) of one group to a single signal;
encoding the multiplexed signals using periodic optical coders with a different code for the signals originating from the different groups; and
combining the encoded signals to a single broadband signal.

40. Method according to claim 39, further comprising separating, decoding and demultiplexing the combined signals.

41. Method for multiplexing broadband signals originating from a plurality of users (60), comprising
encoding broadband signals originating from a plurality of user separately with periodic optical coders, wherein each user (60) is assigned to one of a plurality of groups, and wherein the code used for encoding is different for the different users (60) of the same group;
combining the encoded frequency sets of one group of users (60) into a single signal; and
filtering the signal of each group with a different frequency passband and multiplexing the filtered signals of the different groups to a single fibre.

42. Method according to claim 41, further comprising demultiplexing and decoding the multiplexed signals.

43. Method for coding a broadband signal, comprising:
receiving a broadband signal;
splitting the broadband signal spectrally with at least one optical interleaver (21-23) into different frequency sets with interleaving frequencies;
coding separately at least two of the frequency sets; and
combining the coded frequency sets to a single broadband signal.

44. Method according to claim 43, wherein the frequency sets are coded temporally.

45. Method according to claim 43 or 44, wherein the frequency sets are coded coherently or incoherently.

46. Method according to one of claims 43 to 45, comprising preventing at least one of the frequency sets from being included in the combining of the coded frequency sets.

47. Method according to one of claims 43 to 46, comprising for a received and split broadband signal with a characteristic indicative of the origin of the broadband signal for the step of coding:
determining the origin of the frequency sets; and
coding the frequency sets of each origin separately with a code assigned to the determined origin.

48. Method according to one of claims 43 to 47, comprising after the coding, reflecting the coded frequency sets and combining them by the at least one optical interleaver (21-23) used for splitting the input broadband signal.

49. Method for coding a broadband signal, comprising:
a) receiving a broadband signal;
b) reflecting a first frequency set of the broadband signal with a first fibre Bragg grating (43a) and passing on all remaining frequency sets of the broadband signal;
c) delaying all passed on frequency sets;
d) reflecting a further frequency set of the broadband signal with a further fibre Bragg grating (43b-43d) and passing on all remaining frequency sets of the broadband signal;
e) repeating steps c) and d) for all further frequency sets of the broadband signal desired in the coded broadband signal; and
f) combining the reflected frequency sets to a single broadband signal.

50. Method according to one of claims 43 to 49, wherein broadband signals are coded with a single coder bidirectionally.

51. Method according to one of claims 43 to 50, used for the step of coding of the method of one of claims 39 to 42.

52. Method for constructing an OCDMA network architecture according to one of claims 1 to 11 as upgrade of a WDM network architecture, comprising using at least one WDM component of the WDM network architecture as one of the WDM components of the OCDMA network architecture.

53. Method for constructing an OCDMA network architecture according to one of claims 1 to 11 as upgrade of a WDM network architecture, comprising combining at least two WDM components of the WDM network architecture to a single fibre.

54. Method for upgrading an existing OCDMA network architecture according to one of claims 1 to 11 in order to be able to support more users, comprising adding coders and/or couplers/splitters to the existing OCDMA network.
